(19) United States
(12) Patent Application Publication
(10) Pub. No.: US 2024/0077613 A1
(43) Pub. Date: Mar. 7, 2024

(54) Device and method for detecting objects

(71) Applicant: SICK AG, Waldkrich (DE)

(72) Inventors: Jan JARVIS, Waldkirch (DE); Dominic RUH, Waldkirch (DE); Steffen WITTMEIER, Waldkirch (DE)

(21) Appl. No.: 18/223,743

(22) Filed: Jul. 19, 2023

(30) Foreign Application Priority Data
Jul. 20, 2022 (EP) 22186060.4

(51) Int. Cl. G01S 17/58; G01S 7/4912

(52) U.S. Cl. CPC G01S 17/58; G01S 7/4912

(57) ABSTRACT

A device and a method for detecting objects in a monitored zone are provided. At least one FMCW LiDAR sensor scans a plurality of measurement points in the monitored zone and generates measurement data from transmitted light remitted or reflected by the measurement points, with the measurement data comprising radial speeds of the measurement points. A control and evaluation unit is configured to segment the measurement points and to combine them into objects and/or object segments and to determine a movement pattern of at least one object segment using the radial speeds of the measurement points associated with the object segment.

The invention relates to a device and to a method for detecting objects.

Optoelectronic sensors such as laser scanners or 3D cameras are frequently used for detecting objects, for example for technical safety monitoring. Sensors used in safety engineering have to work particularly reliably and must therefore satisfy high safety demands, for example the EN13849 standard for safety of machinery and the machinery standard IEC61496 or EN61496 for electrosensitive protective equipment (ESPE). To satisfy these safety standards, a series of measures have to be taken such as a safe electronic evaluation by redundant, diverse electronics, functional monitoring or special monitoring of the contamination of optical components.

A machine is safeguarded in DE 10 2007 007 576 A1 in that a plurality of laser scanners record a three-dimensional image of their working space and compare this actual state with a desired state. The laser scanners are positioned at different heights on tripods at the margin of the working space. 3D cameras can also be used instead of laser scanners.

A method and a device for detecting the movements of process units during a production process in a predefined evaluation zone are known from DE 198 43 602 A1. At least two cameras arranged at fixed positions in the evaluation zone are used. Spatial coordinates of each process unit are continuously detected and a translation vector describing the movement of the respective process unit is determined for each spatial coordinate.

U.S. Pat. No. 9,804,576 B2 discloses a recognition-based industrial automation control that is configured to recognize movements of persons, to deduce them for the future, and to compare them with planned automation commands to optionally deduce further safety relevant actions (alarms or changed control commands), with 3D cameras being used to recognize the movements of persons.

DE 10 2006 048 163 B4 describes a camera-based monitoring of moving machines and/or of movable machine elements for collision prevention, with image data of the machine and/or of the movable machine elements being captured with the aid of an image capturing system. The image capturing system can in particular be a multiocular camera system; LiDAR, sensors, RADAR sensors, or ultrasound sensors are furthermore named as possible image capturing systems.

A further area of application of the object detection by means of optoelectronic sensors is traffic monitoring, for example to check vehicle formalities, to calculate toll fees, traffic management, or statistical traffic monitoring. It is known to detect the vehicles in flowing road traffic at so-called measurement gantries that, for example, comprise optical sensors such as laser scanners or cameras to record the vehicle contour. The number and position of the vehicle axles can, for example, subsequently be determined in a corresponding image evaluation. EP 3 183 721 B1 discloses a system for contactless axle counting of a vehicle by means of optical processes for this purpose. The system is camera-based and uses complex image processing, with a further sensor system being able to be used to relieve the image processing with respect to the detection of vehicles. The known visual methods are, however, not particularly robust with respect to poor weather conditions. Since the 3D methods work at a lower resolution as a rule, they are particularly sensitive to snow and rain because the detection of snow and water splashes substantially falsifies the measurement data. The accuracy of the axle detection can therefore be unsatisfactory overall and the processing effort for the image processing is high as a rule.

The image capturing systems typically used for object detection in the prior art, in particular laser scanners and camera systems, additionally have disadvantages that will be looked at in more detail in the following.

Laser scanners or LiDAR (light detection and ranging) sensors are typically based on a direct time of flight measurement. In this respect, a light pulse is emitted by the sensor, is reflected at an object, and is detected by the sensor again. The time of flight of the light pulse is determined by the sensor and the distance between the sensor and the object is estimated via the speed of light in the propagation medium (air as a rule). Since the phase of the electromagnetic wave is not taken into account here, an incoherent measurement principle is spoken of. There is the necessity in an incoherent measurement to build up pulses from a plurality of photons to receive the reflected pulse with a sufficient signal-to-noise ratio. The number of photons within a pulse is upwardly limited as a rule by eye protection in an industrial environment. As a consequence, trade-offs result between maximum range, minimal remission of the object, integration time, and the demands on the signal-to-noise ratio of the sensor system. Incoherent radiation at the same wavelength (environmental light) additionally has a direct effect on the dynamic range of the light receiver. Examples for incoherent radiation at the same wavelength are the sun, similar sensor systems, or the identical sensor system via a multipath propagation, that is unwanted reflections.

Camera systems known from the prior art are based on measurement principles such as stereoscopy or indirect time of flight measurement. In indirect time of flight measurement, the phase difference of an AMCW (amplitude modulated continuous wave) transmission signal and its time delayed copy after reflection by an object is determined. The phase difference corresponds to the time of flight and can be converted into a distance value via the speed of light in the propagation medium. Both stereoscopy and indirect time of flight measurement are likewise incoherent measurement processes with the above-named disadvantages.

Millimeter wavelength radar sensors are based on a frequency modulated continuous wave measurement principle (FMCW) and can also determine radial speeds of a detected object using the Doppler effect. The greatest disadvantage of millimeter wavelength radar sensors in comparison with optical technologies is the considerably greater wavelength and the thus lower spatial resolution. Regulatory specifications furthermore limit the radial resolution by limiting the bandwidth and the angular resolution in a MIMO (multiple input multiple output) radar system by the number of available virtual antennas (product from the number of transmission and reception antennas).

It is therefore the object of the invention to improve a device and a method for detecting objects.

This object is satisfied by a device and by a method in accordance with the respective independent claim.

The device in accordance with the invention for detecting objects in a monitored zone has at least one optoelectronic sensor that is configured as a frequency modulated continuous wave (FMCW) LiDAR sensor. The principles of FMCW LiDAR technology are, described, for example, in the scientific publication “Linear FMCW Laser Radar for Precision Range and Vector Velocity Measurements” (Pierrottet, D., Amzajerdian, F., Petway, L., Barnes, B., Lockard, G., & Rubio, M. (2008). Linear FMCW Laser Radar for Precision Range and Vector Velocity Measurements. MRS Proceedings, 1076, 1076-K04-06. doi:10.1557/PROC-1076-K04-06) or the doctoral thesis “Realization of Integrated Coherent LiDAR” (T. Kim, University of California, Berkeley, 2019. https://escholarship.org/uc/item/1d67v62p).

Unlike a LiDAR sensor based on a time of flight measurement of laser pulses, an FMCW LiDAR sensor does not transmit pulsed transmitted light beams into the monitored zone, but rather continuous transmitted light beams that have a predetermined frequency modulation, that is a time variation of the wavelength of the transmitted light during a measurement, that is a time-discrete scanning of a measurement point in the monitored zone. The measurement frequency is here typically in the range from 10 to 30 Hz. The frequency modulation can be formed, for example, as a periodic up and down modulation. Transmitted light reflected by measurement points in the monitored zone has, in comparison with irradiated transmitted light, a time delay corresponding to the time of light that depends on the distance of the measurement point from the sensor and is accompanied by a frequency shift due to the frequency modulation. Irradiated and reflected transmitted light are coherently superposed in the FMCW LiDAR sensor, with the distance of the measurement point from the sensor being able to be determined from the superposition signal. The measurement principle of coherent superposition inter alia has the advantage in comparison with pulsed or amplitude modulated incoherent LiDAR measurement principles of increased immunity with respect to extraneous light from, for example, other optical sensors/sensor systems or the sun. The spatial resolution is improved with respect to radar sensors having wavelengths in the range of millimeters, whereby geometrical properties of an object become measurable.

If a measurement point moves toward the sensor or away from the sensor at a radial speed, the reflected transmitted light additionally has a Doppler shift. An FMCW LiDAR sensor can determine this change of the transmitted light frequency and can determine the distance and the radial speed of a measurement point from it in a single measurement, that is in a single scan of a measurement point, while at least two measurements, that is two time spaced scans of the same measurement point, are required for a determination of the radial speed with a LiDAR sensor based on a time of flight measurement of laser pulses.

On a time-discrete and spatially discrete scan of a three-dimensional monitored zone, an FMCW LiDAR sensor can detect the following measurement data:

$${M}_{j , k , l} = ( \begin{matrix}{r}_{j , k , l} \\ {v}_{j , k , l}^{r} \\ {I}_{j , k , l}\end{matrix} ) ,$$

where r_{j,k,l} is the radial distance, v^{r}_{j,k,l} the radial speed, and I_{j,k,l} the intensity of each spatially discrete measurement point j, k with a two-dimensional position (φⱼ, θₖ) specified by an azimuth angle φ and a polar angle θ for every time-discrete scan I. For better legibility, the index n is used in the following for a single, time-discrete, scanning of a spatially discrete, two dimensional measurement point (φⱼ, θₖ) in the three-dimensional monitored zone.

To evaluate the measurement data detected by the FMCW LiDAR sensor, the device in accordance with the invention has a control and evaluation unit that is configured to segment the measurement points and to associate them with at least one object segment belonging to the object. For example, single parts of one of an object comprising a plurality of parts are to be understood as object segments here, for example the rump and members of a human body, components of a robot arm, or wheels of a vehicle.

The control and evaluation unit is furthermore configured to determine a movement pattern of the first object segment using spatially resolved radial speeds of measurement points associated with at least one first object segment. A movement pattern is to be understood as a characteristic own movement of the object segment, for example a rotation or a relative movement of the object segment with respect to the object itself or with respect to a further object segment that results from a radial speed profile of the measurement points associated with the object segment. A corresponding characteristic own movement or characteristic radial speed profile can, for example, be stored in the control and evaluation unit as a predetermined movement pattern, can be detected in a teaching process, or can be determined during the operation of the device by means of methods of machine learning or artificial intelligence.

The use of the spatially resolved radial speeds to determine a movement pattern of the measurement points associated with a first object segment has the advantage that the movement pattern of the object segment can be determined quickly and reliably.

The determination of a movement pattern of an object segment, in particular the determination of a relative movement between different object segments or of object segments with respect to the object itself can be used, for example with a robot, to determine future robot poses.

As part of traffic monitoring, it is possible to recognize whether the wheels of a vehicle are turning or not, for example using the movement pattern of wheels of the vehicle. An axle recognition can thus be improved, for example, since the wheels of a raised axle do not rotate or do not rotate at the same speed as wheels that have contact with the ground.

The segmentation and association of the measurement points with respect to an object and/or to at least one object segment belonging to the object can preferably take place using the spatially resolved radial speed of the measurement points. An improved segmentation of the measurement data is possible by the use of the spatially resolved radial speed as an additional parameter.

The control and evaluation unit can furthermore be configured to determine radial speeds of the at least one object and/or of the at least one object segment belonging to the object and to extract features of the object and/or of the object segment that are based on the radial speeds of the object or of the object segment. The extracted features can, for example, be statistical measurements such as a mean value or a standard deviation, higher torques, or histograms of the radial speeds of the object and/or object segment that can be characteristic for an object movement and/or an object segment movement.

The control and evaluation unit can advantageously be configured to use the features based on the radial speeds of the object and/or of the object segment for a classification of the object and/or of the object segment. An improved classification of the object and/or of the object segment is possible by these additional features.

In an embodiment, the control and evaluation unit can be configured to filter the measurement data using the radial speeds of the measurement points. The processing effort can thus already be reduced by data reduction before a segmentation of the measurement points. A filtering can take place, for example, in that measurement points having a radial speed that is smaller than, greater than, or equal to a predefined threshold value are discarded and are not supplied to any further evaluation. Objects and/or object segments that move with the sensor (v^{r}=0) or that move away from the sensor (v^{r}>0), can, for example, be discarded in the event of an anticollision function.

The FMCW LiDAR sensor can be arranged as stationary and can scan a predefined monitored zone. At least one further FMCW LiDAR sensor can preferably be provided that scans a further monitored zone, with the monitored zones being able to overlap. Shading or blind angles in which no object detection is possible can thereby be avoided. If two or more FMCW LiDAR sensors are arranged with respect to one another such that measurement beams can be generated that are orthogonal to one another, a speed vector of an object scanned by these measurement beams in the plane spanned by the mutually orthogonal measurement beams can be determined by offsetting.

The FMCW LiDAR sensor can be arranged at a machine, in particular at an automated guided vehicle (AGV) or at a robot. The robot can be entirely in motion (mobile robot) or can carry out movements by means of different axles and joints. The sensor can then also perform movements of the machine and scan a varying monitored zone.

The sensor can be adapted as a safety sensor in the sense of the standards named in the introduction or comparable standards. The control and evaluation unit can be integrated in the sensor or can be connected thereto, for instance in the form of a safety controller or of a superior controller that also communicates with the machine control. At least some of the functions can also be implemented in a remote system or in a cloud.

The sensor can preferably be attached to or in the vicinity of a hazardous machine part such as a tool tip. If it is, for example, a robot having a number of axles, their interaction is not relevant to the sensor since the sensor simply tracks the resulting movement at the hazard location.

In a further development of the invention, a plurality of optoelectronic sensors can be attached to the machine to determine the movement of movable parts of the machine. Complex machines can thus also be monitored in which a punctiform determination of the movement is not sufficient. An example is a robot having a plurality of robot arms and possibly joints. At least one stationary sensor, that is an optoelectronic sensor not moved together with the machine, can additionally observe the machine.

In a further embodiment of the invention, the device can be configured for a monitoring of a lane. The device can here have one or more FMCW LiDAR sensors that are arranged over and/or next to a track of a lane to be monitored such that one or both sides of a vehicle can be detected when the vehicle passes by the FMCW LiDAR sensor or sensors. The control and evaluation device can in particular be configured to determine a speed of the vehicle and/or a movement pattern, in particular a rotation of wheels, of the vehicle.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

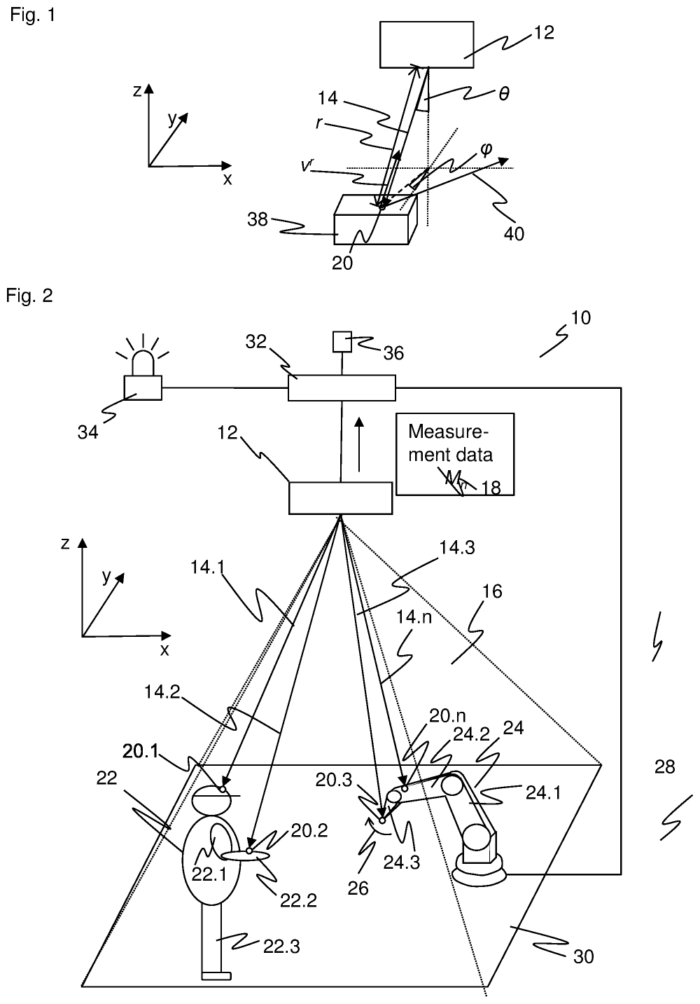

FIG. 1 an example for a radial speed measurement using an FMCW LiDAR sensor;

FIG. 2 a schematic representation of a device in accordance with the invention for monitoring a robot;

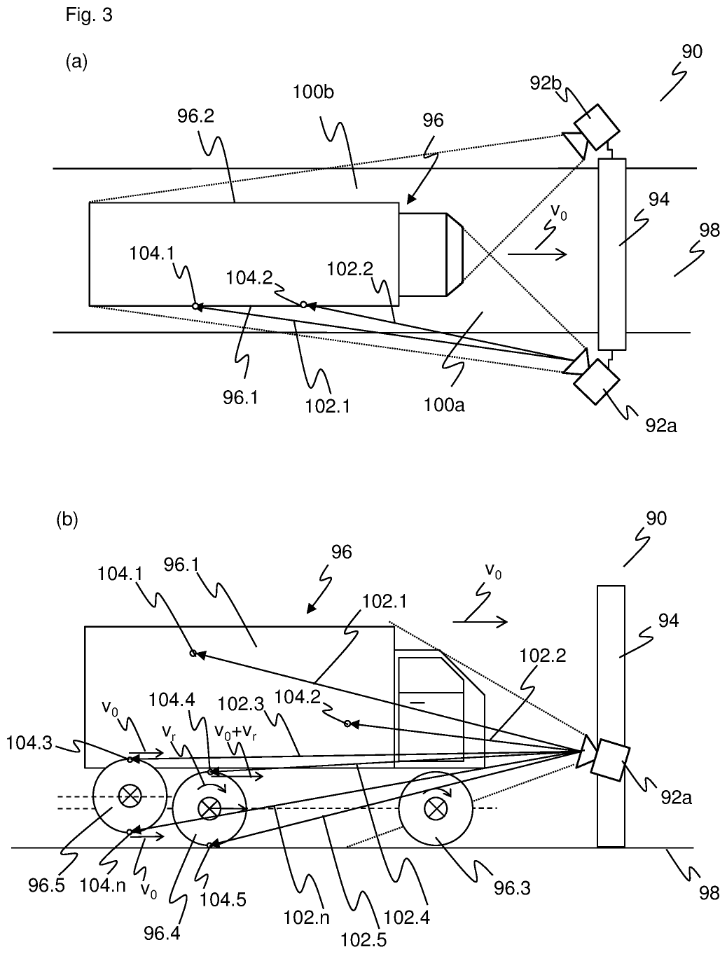

FIG. 3 a schematic representation of a device in accordance with the invention for traffic monitoring;

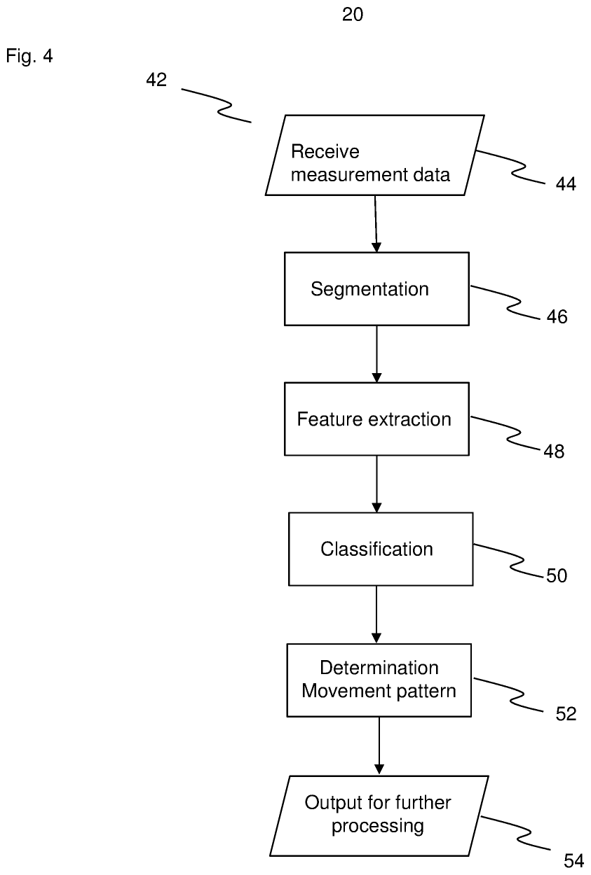

FIG. 4 a flowchart for an exemplary processing in accordance with the invention of measurement data of an FMCW LiDAR sensor;

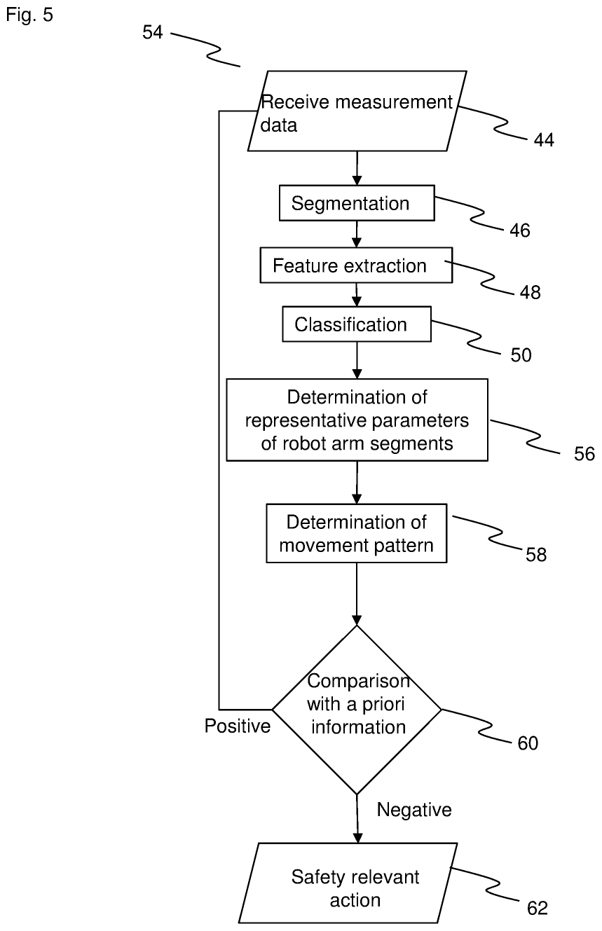

FIG. 5 an exemplary flowchart for monitoring a movement of a robot using a method in accordance with the invention; and

The concept of the radial speed measurement using an FMCW LiDAR sensor 12 is shown for a three-dimensional example in FIG. 1. If an object 38 moves along a direction of movement 40 relative to the FMCW LiDAR sensor 12, the FMCW LiDAR sensor 12 can determine the radial speed v^{r} of the measurement point 20 of the object 38 in the direction of the FMCW LiDAR sensor 12 in addition to the radial distance r and the intensity I of a measurement point 20 scanned once by a transmitted light beam 14 in a time-discrete manner at an azimuth angle φ and a polar angle θ. This information is available directly on a measurement, that is on a time-discrete scanning of the measurement point 20. Unlike measurement processes that only deliver spatially resolved radial distances, that is three-dimensional positions, the necessity of a second measurement and in particular the necessity of first determining the measurement points that correspond to the measurement points of the first measurement in the measurement data of the second measurement is thus dispensed with for the identification of moving objects.

In the case of a static FMCW LiDAR sensor, every measurement point having a radial speed of zero is as a rule associated with a static object provided that the latter does not move tangentially to the measurement beam. Due to the finite object extent and to the high spatial resolution of the FMCW LiDAR sensor, practically every moving object will have at least one measurement point 20 having a radial speed v^{r}ₙ with respect to the FMCW LiDAR sensor 12 different from zero. Static and moving objects or objects moving away or approaching in mobile applications can therefore already be distinguished by one measurement of the FMCW LiDAR sensor 12. With an anti-collision monitoring, for example, measurement points moving away respectively objects moving away can thus be discarded. Processing efforts in the further evaluation of the measurement data are reduced by a corresponding data reduction.

FIG. 2 shows a schematic representation of a device 10 in accordance with the invention for monitoring a robot 24. An FMCW LiDAR sensor 12 transmits transmitted light beams 14.1, . . . , 14.n into a three-dimensional monitored zone 16 and generates measurement data Mₙ 18 from transmitted light reflected or remitted back to the FMCW LiDAR sensor 12 by measurement points 20.1, . . . , 20.n in the monitored zone 16. A limited number of exemplary transmitted light beams 14.1, . . . , 14.n and measurement points 20.1, . . . , 20.n is shown for illustration; the actual number results from the size of the monitored zone 16 and the spatial resolution of the scan. The measurement points 20.1, . . . , 20.n can represent persons 22, robots 24, or also boundaries of the monitored zone such as floors 39 or walls in the monitored zone 16.

The measurement data Mₙ 18 of the FMCW LiDAR sensor 12 received by the control and evaluation unit 32 in particular comprise the radial speeds v^{r}ₙ of the measurement points 20.1, . . . , 20.n for every time-discrete scan in addition to the radial distances rₙ and the intensities Iₙ, that is the remitted or reflected amount of transmitted light, where the speed component of a measurement point 20.1, . . . 20.n is designated by the radial speed v^{r}ₙ at which the measurement point 20.1, . . . , 20.n moves toward the FMCW LiDAR sensor 12 or away from the FMCW LiDAR sensor 12.

The measurement data Mₙ 18 are evaluated by a control and evaluation unit 32, with the control and evaluation unit 32 being configured to detect movement patterns of the object segments 22.1, 22.2, 22.3, 24.1, 24.2, 24.3 using the radial speeds v^{r}ₙ of the measurement points 20.1, . . . , 20.n, for example a pivot movement 26 of the robot arm 24.3. Based on said detection, the control and evaluation unit 32 can generate a safety relevant signal for triggering a safety relevant action. The safety relevant action can, for example, be the activation of a warning light 34 or the stopping of the robot 24. In the embodiment, the control and evaluation unit 32 is directly connected to the warning light 34 and to the robot 24, that is it triggers the safety relevant action itself. Alternatively, the control and evaluation unit 32 can forward a safety relevant signal to a superior safety controller (not shown) via an interface 36 or the control and evaluation unit 32 itself can be part of a safety controller.

FIG. 3 shows a schematic representation ((a) plan view, (b) side view) of a device 90 in accordance with the invention for traffic monitoring. One or more FMCW LiDAR sensors 92a, 92b are arranged at a so-called toll gantry or traffic sign gantry 94 to detect a vehicle, in this case a truck 96 on a lane 98. The FMCW LiDAR sensors 92a, 92b are arranged above or to the side of the lane 98 to be monitored such that one or both vehicle sides 96.1, 96.2 and wheels 96.3, 96.4, 96.5 of the vehicle 96 are detected when the vehicle 96 passes through the monitored zone 100a, 100b of the sensors 92a, 92b.

The FMCW LiDAR sensor sensors 92a, 92b transmit transmitted light beams 102.1, . . . , 102.n into the three-dimensional monitored zones 100a, 100b of the sensors 92a, 92b and generate measurement data from transmitted light reflected or remitted back to the sensors 92a, 92b by measurement points 104.1, . . . , 104 in the monitored zones 100a, 100b). The measurement data are evaluated by a control and evaluation unit (not shown).

Measurement points 104.1, 104.2 on static object segments of the vehicle 96, for example on the vehicle side 96.1, have radial speeds in the measurement data that only differ from the speed of the vehicle in the direction of movement as described in FIG. 1 due to the lateral angular difference between the direction of movement and the direction of measurement. Measurement points 104.4, 104.5 at object segments have an additional relative movement with respect to the vehicle such as rotating wheels 96.3, 96.4 have radial speeds in the measurement data that differ significantly from the radial speeds of the static object segments of the vehicle. In particular wheels 96.5 at a raised axle of the vehicle 96 can belong to the static object segments of the vehicle since they do not rotate.

Looking at the side view of the vehicle 96 shown in b) illustrates this. A measurement point 104.4 at the highest point of the wheel 96.4 having contact with the ground has a rotation component vᵣ in addition to the movement speed v₀ of the vehicle, whereby a total speed of v₀+vᵣ results. At the measurement point 104.5 at which the wheel 96.4 contacts the ground 98, the rotational speed vᵣ and the movement speed v₀ of the vehicle cancel each other out due to the direction of rotation. The radial speed of this measurement point 104.5 at the rotating wheel 96.4 is thus measured as 0 by the sensor. A characteristic movement pattern or radial speed profile thus results for a rotating wheel that can be determined from the measured radial speeds.

A wheel 96.5 at a raised axle will not rotate as a rule and therefore has the same speed v₀ at all the measurement points 104.3, 104.n that corresponds to the speed of movement v₀ of the vehicle 96.

Wheels or axles rotating at the vehicle can thus be reliably detected so that an improved axle count is made possible.

FIG. 4 shows an exemplary processing in accordance with the invention of the measurement data detected by the FMCW LiDAR sensor by the control and evaluation unit in a flowchart 42. After the reception 44 of the measurement data, the measurement points 20.1, . . . 20.n, 104.1, . . . , 104.n are segmented in a segmentation step 46 and are combined into objects 22, 24, 96 and/or object segments 22.1, 22.2, 22.3, 24.1, 24.2, 24.3, 96.1, . . . , 96.5, with in particular the spatially resolved radial speeds v^{r}ₙ of the measurement points 20.1, . . . , 20.n 104.1, . . . , 104.n being able to be taken into account in addition to the spatial coordinates typically used for the segmentation and the intensities of the measurement points. Object segments can, for example, be individual movable components 24.1, 24.2, 24.3 of a robot 24, body parts 22.1, 22.2, 22.3 or a person 22, or wheels 96.3, 96.4, 96.5 of a vehicle 96.

The segmentation 46 can take place in accordance with known processes of digital image processing or of machine vision such as
pixel oriented processes in a gray scale image by means of threshold processes;
edge oriented processes such as the Sobel or Laplace operator and a gradient search;
region oriented processes such as “region growing”, “region splitting”, “pyramid linking”, or “split and merge”;
model based processes such as the Hough transformation; or
texture oriented processes.

Special processes for segmenting three-dimensional datasets are furthermore known under the term “range segmentation”. The “range segmentation” is, for example, described in the following scientific publications:
“Fast Range Image-Based Segmentation of Sparse 3D Laser Scans for Online Operation” (Bogoslayskyi et al., 2016 IEEE/RSJ International Conference on Intelligent Robots and Systems, DOI: 10.1109/IROS.2016.7759050)
“Laser-based segment classification using a mixture of bag-of-words”. (Behley et al., 2013 IEEE/RSJ International Conference on Intelligent Robots and Systems, DOI: 10.1109/IROS.2013.6696957)
“On the segmentation of 3d lidar point clouds” (Douillard et al., 2011 IEEE International Conference on Robotics and Automation, DOI: 10.1109/ICRA.2011.5979818)

The segmentation 46 of the measurement points 20.1, . . . , 20.n, 104.1, . . . , 104.n can take place more efficiently and accurately using the above-named processes by the use of the radial speed v^{r}ₙ in addition to the radial distance rₙ and the intensity Iₙ of the measurement points 20.1, . . . , 20.n, 104.1, . . . , 104.n. For example, measurement points 20.1, . . . 20.n, 104.1, . . . , 104.n having radial speeds v^{r}ₙ smaller than, greater than, or equal to a predefined threshold value can be discarded and not supplied to any further evaluation. In the case of an anticollision function, for example, measurement points of an object and/or object segment that move with the sensor (v^{r}=0) or that move away from the sensor (v^{r}>0) can be discarded. If an object and/or object segment is/are scanned by a plurality of spatially discrete measurement points and if the associated radial speeds are distinguishable, static and dynamic objects and/or object segments can be distinguished and thus stationary objects and/or object segments such as floors 30, lanes 98, or walls can already be discarded before or during the segmentation 46 of the measurement points 20.1, . . . , 20.n, 104.1, . . . , 104.n and the processing effort can be reduced by data reduction.

In the next step, a feature extraction 48 of the objects 22, 24, 30, 96 and/or object segments 22.1, 22.2, 22.3, 24.1, 24.2, 24.3., 96.1, . . . , 96.5 defined during the segmentation 46 can take place. Typical features that can be extracted in the processing of the measurement data from the objects 22, 24, 30, 96 and/or object segments 22.1, 22.2, 22.3, 24.1, 24.2, 24.3, 96.1, . . . , 96.5 are, for example, the width, number of measurement points, or the length of the periphery of the objects and/or object segments or further features such as described, for example, in the scientific publication “A Layered Approach to People Detection in 3D Range Data” (Spinello et al., Proceedings of the Twenty-Fourth AAAI Conference on Artificial Intelligence, AAAI 2010). In accordance with the invention, these features can be expanded by features that are based on the radial speeds of the objects 22, 24, 30, 96 and/or object segments 22.1, 22.2, 22.3, 24.1, 24.2, 24.3, 96.1, . . . , 96.5. For this purpose, radial speeds of the objects and/or object segments are first determined, for example by application of trigonometric functions to the radial speeds of the measurement points representing the respective object and/or object segment. Statistical dimensions of the radial speeds of the objects and/or object segments such as the mean value, standard deviation, higher torques, or histograms that are characteristic for movements of a robot and/or person can then be used as additional object features or object segment features, for example.

After the feature extraction 48, a classification 50 of the objects 22, 24, 96 and/or object segments 22.1, 22.2, 22.3, 24.1, 24.2, 24.3, 96.1, . . . , 96.5 takes place using known classification processes such as Bayes classifiers, support vector machines, or artificial neural networks. The feature space is searched for groups of features that define an object as part of the classification. In this respect, the above-listed statistical measurements of the radial speed of individual objects 22, 24, 30, 96 and/or object segments 22.1, 22.2, 22.3, 24.1, 24.2, 24.3, 96.1, . . . , 96.5 can be used with a priori information to define feature spaces that can, for example, classify persons 22 or vehicles 94 based on their radial speed and can thus distinguish them.

In a further step 52, the determination of a movement pattern of at least one of the object segments 22.1, 22.2, 22.3, 24.1, 24.2, 24.3, 96.1, . . . , 96.5 now takes place using the radial speeds of the measurement points 20.1, . . . , 20.n, 104.1, . . . , 104.n associated with the at least one object segment.

The result of the determination of the movement pattern 52 can be further processed by the control and evaluation unit 32 after the output, for example to generate a safety relevant signal, to recognize a state of an object segment (wheel rotates or not), or can be forwarded to a superior controller (not shown) via the interface 36.

FIG. 5 shows an exemplary flowchart 54 for monitoring a movement of a robot using a method in accordance with the invention. As described above, the steps of segmentation 46 of the measurement data Mₙ, feature extraction 48, and classification 50 take place after the reception 44 of the measurement data Mₙ. A determination 56 of representative parameters such as radial distances, intensities, and radial speeds of the segments 24.1, 24.2, 24.3 takes place for segments 24.1, 24.2, 24.3 of the robot arm identified in the classification 50.

A recognition of a movement pattern 58 takes place based on the measured radial speeds of the measurement points associated with previously classified segments 24.1, 24.2, 24.3. Unlike the typical determination of a “rigid scene flow” based on 3D position data as described, for example, in
Dewan, Ayush, et al. “Rigid scene flow for 3d lidar scans.” 2016 IEEE/RSJ International Conference on Intelligent Robots and Systems (IROS). IEEE, 2016.
   or
Liu, Xingyu, Charles R. Qi, and Leonidas J. Guibas. “Flownet3d: Learning scene flow in 3d point clouds.” Proceedings of the IEEE Conference on Computer Vision and Pattern Recognition, 2019,
   the measured radial speed values can be used directly for recognizing a movement pattern so that in particular two scans M_{n,l} and M_{n,l-1} of the monitored zone consecutive in time are not absolutely necessary. In a comparison step 60, a comparison of the movement pattern 58 with a priori information on expected desired movements of the segments 24.1, 24.2, 24.3 of the robot arm takes place. On a negative result of the comparison 50 (for example a movement deviation above a specified degree of tolerance), a safety relevant action 62 is initiated, for example a switching off of the robot 24.

1. A device for detecting at least one object comprising a plurality of object segments in a monitored zone having
at least one FMCW LiDAR sensor for transmitting transmitted light beams into the monitored zone, for scanning a plurality of measurement points and for generating measurement data from transmitted light remitted or reflected by the measurement points, with the measurement data comprising radial speeds of the measurement points;
a control and evaluation unit for evaluating the measurement data, with the control and evaluation unit being configured to segment the measurement points and to associate them at least in part with the object segments,
wherein the control and evaluation unit is further configured to determine a movement pattern of at least one of the object segments using the radial speeds of the measurement points associated with the object segments.

2. The device in accordance with claim 1, wherein the control and evaluation unit is configured to segment the measurement points using the radial speeds and to associate them at least in part with the object segments.

3. The device in accordance with claim 1, wherein the control and evaluation unit is configured to determine radial speeds of the objects and/or object segments and to extract features of the objects and/or object segments using the radial speeds of the objects and/or object segments.

4. The device in accordance with claim 3, wherein the control and evaluation unit is configured to classify the objects and/or object segments using the radial speeds of the objects and/or object segments.

5. The device in accordance with claim 1, wherein the control and evaluation unit is configured to filter the measurement points using the radial speed of the measurement points.

6. The device in accordance with claim 5, wherein the control and evaluation unit is configured to discard measurement points having a radial speed below a predefined threshold value for the evaluation.

7. The device in accordance with claim 1, wherein the FMCW LiDAR sensor is stationary.

8. The device in accordance with claim 7, wherein the device has at least one further FMCW LiDAR sensor having a further monitored zone and the monitored zone at least partly overlaps the further monitored zone.

9. The device in accordance with claim 1, wherein the device is configured to detect vehicles on a lane, with the control and evaluation device being configured to determine a rotation of wheels of the vehicle.

10. A method for detecting at least one object comprising a plurality of object segments in a monitored zone, said method comprising the steps:
transmitting transmitted light beams into the monitored zone by at least one FMCW LiDAR sensor;
scanning a plurality of measurement points in the monitored zone;
generating measurement data from transmitted light remitted or reflected by the measurement points, with the measurement data comprising radial speeds of the measurement points;
segmenting the measurement points and at least partially associating the measurement points with the object segments;
determining a movement pattern of at least one of the object segments using the radial speeds of the measurement points associated with the object segments.

11. The method in accordance with claim 10, wherein the measurement points are segmented using the radial speeds of the measurement points and are combined into objects and/or object segments.

12. The method in accordance with claim 10, comprising the further steps:
determining radial speeds of the objects and/or object segments; and
extracting features of the objects and/or object segments using the radial speeds of the objects and/or object segments.

13. The method in accordance with claim 12, comprising the further step:
classifying the objects and/or object segments using the radial speeds of the objects and/or object segments.

14. The method in accordance with claim 11, comprising the further step:
filtering the measurement points using the radial speeds of the measurement points.

15. The method in accordance with claim 14, wherein measurement points having a radial speed below a predefined threshold value are discarded for the evaluation.
